(19) United States
(12) Patent Application Publication
(10) Pub. No.: US 2009/0007185 A1
(43) Pub. Date: Jan. 1, 2009

(54) Wireless Network System and Devices

(75) Inventors: Andrew R. Nix, Bristol (GB); Andrew George Lillie, Bristol (GB)

Correspondence Address: ROTHWELL, FIGG, ERNST & MANBECK, P.C., 1425 K STREET, N.W., SUITE 800, WASHINGTON, DC, 20005, US

(73) Assignee: British Sky Broadcasting Limited, Isleworth, GB (GB)

(21) Appl. No.: 11/630,394

(22) PCT Filed: Jul. 1, 2005
(86) PCT No.: PCT/GB05/02595

§ 371 Date: Mar. 6, 2008

(30) Foreign Application Priority Data
Jul. 1, 2004 (GB) 0414819.3

(51) Int. Cl. H04N 7/16

(52) U.S. Cl. 725/62

(57) ABSTRACT

A wireless network device (4), such as a wireless media centre, has orthogonally polarised antennas (6a, 6b) arranged to provide transmit and/or receive polarisation diversity. The antennas may be arranged so that their nulls do not coincide, to produce a combined antenna pattern with a low variation of gain with direction. The antennas may be collocated, but arranged orthogonally. Preferably, the combined antenna pattern is substantially omnidirectional in elevation as well as azimuth. This arrangement provides uniform coverage in a 3D environment. The transmitter may transmit data using polarisation-time block codes. A wireless receiver (10, 18) for use in the wireless network may have either one antenna or two orthogonally polarised antennas. The receiver (10, 18) applies maximal ratio combining to the received signals. The signals may be OFDM signals and the receiver applies maximal ratio combining independently to each frequency channel. The antennas may be flat linear or annular slot antennas, which provide strongly polarised beams and can be integrated within the housing of the devices.

### FIELD OF THE INVENTION

The present invention relates to a wireless network system and devices for use in that system, and particularly but not exclusively for transmitting media content over a wireless network. In particular, the invention is applicable to a video broadcast receiver which distributes video content over a wireless local area network (WLAN).

### BACKGROUND OF THE INVENTION

With the widespread availability of digital media content, there has been intense interest in developing a media centre for storing and playing back a collection of digital media content, such as digitally encoded and compressed audio and video files. In particular, it is desirable to distribute selected media files from a wireless home media centre on demand to wireless audio and video players distributed around the user's house.

Currently, the most widely implemented WLAN standards are the IEEE 802.11 b and g standards, which provide a quoted bit-rate of 11 and 54 Mbps respectively. The IEEE 802.11g standard in particular has been adopted for wireless home media systems, in view of its higher bit rate. An MPEG-2 encoded video stream requires between 2 and 9 Mbps and an HDTV stream around 20 Mbps, so that at first sight the IEEE 802.11g standard seems suitable for carrying at least one video stream.

In reality, wireless home media systems based on the 802.11g standard have not provided satisfactory performance for consumers, for a number of reasons. First, the standard includes a high signaling overhead, and uses a fairly inefficient stop-and-wait medium access control (MAC) method, resulting in only about 16 Mbps being available to the application layer, even in ideal conditions. Next, the home environment causes significant blocking, if the transmitter and receiver are not in the same room; for example, a wall might incur 10 dB attenuation. Significant propagation loss is incurred as the distance between the receiver and the transmitter increases. Furthermore, the user cannot be required to position the media centre in an ideal, central location and at an ideal orientation. Also, the 2.4 GHz band used by 802.11 b/g is subjected to interference from domestic microwave ovens, and from Bluetooth devices. Finally, people moving around the house add fast fading to the transmitted signal. The result is that an 802.11g standard network cannot reliably distribute even one high-quality video stream throughout the typical house, because the existing wireless network technology cannot reliably provide a constant required minimum bandwidth.

Some solutions have been proposed. For example, a system from ViXs involves monitoring the available WLAN bandwidth and changing the video coding rate in real time so as to maintain a steady frame rate; although the video quality deteriorates with reduced bandwidth, the error rate is kept to an acceptable level and frames are not lost. The Air5™ system from Magis modifies the 802.11a standard to provide different quality of service (QoS) levels, allowing video to be prioritized over other data.

To some extent, fluctuations in available bandwidth could be overcome by buffering the media stream at the receiver. However, this solution is not suitable for an interactive system, where a user at the receiver wants to change the content of the media stream, for example to change channels or to rewind or fast forward a programme. The delay caused by buffering causes a corresponding delay in the response to commands from the user, which is not acceptable, particularly when the user wants to ‘surf’ by rapidly changing channels.

A further application of a wireless media centre is as a broadcast gateway for receiving video broadcasts and distributing them over a wireless link. For example, Sky™ digital broadcast receivers include a tvLINK™ function which allows audio and video output to be relayed to a remote display, via an analog wireless link with a return link for remote control commands. This system provides a simple point-to-point wireless link and does not allow multiple devices to receive wireless audio/video steams independently, and there is some loss of quality due to analog conversion prior to retransmission.

Digital broadcast receivers may receive broadcasts in an encrypted format, to enforce digital rights management (DRM) so that only subscribers having a card bearing the decryption key can access the service. Typically, the unencrypted broadcast is only output from the receiver in analog format, so that the content cannot be redistributed without loss of quality (and because most television sets only have analog video inputs). In this case, the media stream cannot be recoded for improved performance over a wireless network, as this would require decryption prior to transmission, which would allow the unencrypted data to be easily accessed in digital form. Even if the data were re-encrypted prior to transmission, this would require the re-encryption technology to be present in the transmitter, from which the necessary decryption key could be derived with relative ease. Hence, at least one of the proposed solutions is incompatible with DRM.

### STATEMENT OF THE INVENTION

According to one aspect of the present invention, there is provided a wireless network device having orthogonally polarised antennas arranged to provide transmit and/or receive polarisation diversity. An advantage is that the polarisation diversity provides enhanced resistance to fast fading, and less sensitivity to the orientation of the device.

The antennas may be arranged so that their nulls do not coincide, to produce a combined antenna pattern without substantial variation in gain. The antennas may be collocated, but arranged orthogonally. Preferably, the combined antenna pattern is substantially hemispherical in elevation and omnidirectional in azimuth. An advantage is that this provides uniform coverage in a 3D environment.

The antennas may be integrated within or mounted on a housing of the device so that they do not physically project outside the housing. Where the housing is cuboid, the antennas may be flush with one or more of the faces of the housing. Advantages include reduced risk of damage to the antennas, greater ease of use in that there is no need to install or align the antennas, and convenient use of the housing as a ground plane for the antennas, where the housing is electrically conductive.

The invention may provide a wireless network system comprising a transmitter having two orthogonally polarised antennas and a receiver having either one antenna or two orthogonally polarised antennas. In the latter case, the receiver may apply maximal ratio combining to the signals received through the two antennas. The transmitter may transmit data using polarisation-time block codes, providing improved gain and resistance to fading.

The transmitter may transmit using OFDM; preferably, the receiver applies maximal ratio combining independently to each frequency channel. The transmitter may transmit in a spectrum substantially free from interference from domestic appliances, such as in the 5.2 GHz band. The wireless network physical layer may be similar to the 802.11a standard.

The transmitter may be a wireless media centre arranged to distribute digital media content over the wireless network. The transmitter may store the content prior to transmission. The transmitter may receive the content as a broadcast prior to distribution over the network. The transmitter may be responsive to commands received from a user of the receiver to vary the transmitted media content.

According to another aspect of the present invention, there is provided a slot antenna comprising a thin cavity with a slot in one major face, and a strip conductor extending orthogonally to the slot, substantially centrally within the cavity. The slot may be linear, or annular. The antenna is capable of generating a highly polarised beam. The antenna can be conveniently mounted on a conductive surface of a wireless device, which provides the ground plane. The device may have two such antennas, arranged orthogonally on the same or different faces of the housing. The antennas may be collocated, for example with their slots crossing orthogonally parallel to the same ground plane.

### BRIEF DESCRIPTION OF THE DRAWINGS

Specific embodiments of the present invention will now be described with reference to the accompanying drawings, in which:

FIG. 1 is a schematic diagram of a wireless network in an embodiment of the present invention;

FIG. 2 is a schematic diagram of a block code architecture used in the wireless network including a receiver with two receive antennas;

FIG. 3 is a schematic diagram of a block code architecture used in the wireless network including a receiver with a single receive antenna;

FIGS. 4a and 4b are graphs of respectively BER and PER against SNR for different 802.11a modes in a simulation with no diversity;

FIGS. 5a and 5b are graphs of respectively BER and PER against SNR for different 802.11a modes in a simulation with STBC and a single receive antenna;

FIGS. 6a and 6b are graphs of respectively BER and PER against SNR for different 802.11a modes in a simulation with STBC and two receive antennas;

FIGS. 7a and 7b show a linear slot antenna for use in the wireless network;

FIGS. 8a and 8b show the far field gain patterns of the linear slot antenna for horizontal and vertical polarisation respectively;

FIGS. 9a and 9b show the co-polar and cross-polar patterns of the linear slot antenna;

FIG. 10 is a plan view of an annular slot antenna for use in the wireless network;

FIGS. 11a and 11b show the far field gain patterns of the annular slot antenna for horizontal and vertical polarisation respectively;

FIGS. 12a and 12b show respectively the co-polar and cross-polar components of the annular slot antenna for an equal signal applied to all feeds;

FIGS. 13a and 13b show respectively the co-polar and cross-polar components of the annular slot antenna for a signal applied with opposite phase between two of the feeds;

FIGS. 14a and 14b show respectively the co-polar and cross-polar components of the annular slot antenna for a signal applied to one feed and the same signal applied with opposite phase and half amplitude to the other two feeds;

FIG. 15 shows possible antenna positions on the housing of a wireless network device;

FIG. 16 is a schematic diagram of an embodiment comprising a combined satellite television receiver and wireless gateway;

FIG. 17 is a schematic diagram of a first receiver for use with the wireless gateway; and

FIG. 18 is a schematic diagram of a second receiver for use with the wireless gateway.

### DETAILED DESCRIPTION OF EMBODIMENTS

### Wireless Media Distribution Network

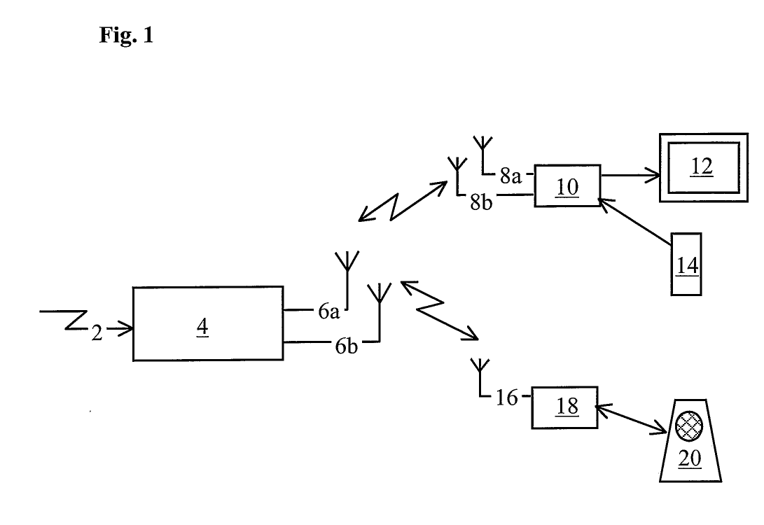

FIG. 1 shows a wireless network used for local wireless media distribution in an embodiment of the invention. A wireless gateway 4 receives media content from a broadcast link 2. The broadcast link 2 may be a satellite or cable television broadcast link, in which case the wireless gateway includes a satellite or cable television receiver, or a connection to an external network such as a broadband internet connection, in which case the wireless gateway 4 includes an external network adapter such as a broadband modem. The broadcast link may carry one or more media channels, each comprising audio and/or video programmes.

The wireless gateway 4 is arranged to select one or more of the programmes for storage and/or distribution to one or more wireless receivers 10, 18. In this example, a first wireless receiver 10 is connected to an audiovisual display 12, such as a television, and receives audio and video signals from the wireless gateway 4 for output to the audiovisual display 12. The first wireless receiver 10 receives commands from a remote control 14 which are relayed back to the wireless gateway 4 to vary the audio and/or video signals. For example, the commands may change the channel and/or programme of the audio and video signals, or move backwards or forwards through a programme stored at the wireless gateway 4.

A second wireless receiver 18 is connected to an audio player 20, and receives audio signals from the wireless gateway 4 for output to the audio player 20. Commands generated by user input at the audio player 20 are relayed back to the wireless gateway 4 to vary the audio signals, for example to change audio channel or programme, or to move backwards or forwards through a programme stored at the wireless gateway.

### Polarisation Diversity

The wireless gateway transmits and receives through a pair of antennas 6a, 6b having orthogonal polarisation. It is not necessary that the antennas are completely orthogonal, but the performance of the system improves with greater isolation between the two antennas.

The first receiver 10 receives through a pair of antennas 8a, 8b, also having orthogonal polarisation, and may transmit through one or both of these antennas. The second receiver 18 has a single antenna 16 through which it receives signals from both of the transmit antennas 6a, 6b. The single antenna 16 need not be polarised.

Using orthogonally polarised receive and transmit antennas provides polarisation diversity, which helps to overcome fast fading as the orthogonal polarisations are likely to be attenuated by different amounts and at different times. The signals received by the two antennas 8a, 8b can be switched so that the signal of higher amplitude is selected as input to a demodulator, or the two signals can be combined using maximal ratio combining with a variable phase selected so as the maximize the summed amplitude of the two signals before demodulation. Such a system with multiple transmit antennas and multiple receive antennas is known as a MIMO (multiple input, multiple output) system.

### Polarisation-Time Block Coding

A greater gain can be obtained by the application to polarisation diversity of space-time block coding (STBC), as described for example in “A simple transmit diversity technique for wireless communications”, Alamouti M, IEEE Journal on Selected Areas in Communications, Vol. 16, No. 8, October 1998 and U.S. Pat. No. 6,185,258 (‘Alamouti’), and generalised in “Space-time block coding for wireless communications: performance results”, Tarokh V, Jafarkhani H, Calderbank A R, IEEE Journal on Selected Areas in Communications, Vol. 17 No. 3, March 1999, pp. 451-460 (‘Tarokh’). In the coding scheme proposed by Alamouti, the data to be transmitted is mapped onto blocks each comprising two symbols s₁, s₂. The symbols correspond to modulation symbols of the modulation scheme to be used for transmission. The output to the two transmit antennas a₁, a₂ at time intervals t₁ and t₂ is as follows:

| | t₁ | t₂ |
|---|---|---|
| a₁ | s₁ | −s₂* |
| a₂ | s₂ | s₁* |

where * denotes a complex conjugate

Alternatively, the symbols may be transmitted at two different frequencies, instead of at different times. At the receiver, the received signal is applied to a channel estimator and to a combiner, which provide inputs to a maximum likelihood detector which recovers the two symbols s₁, s₂.

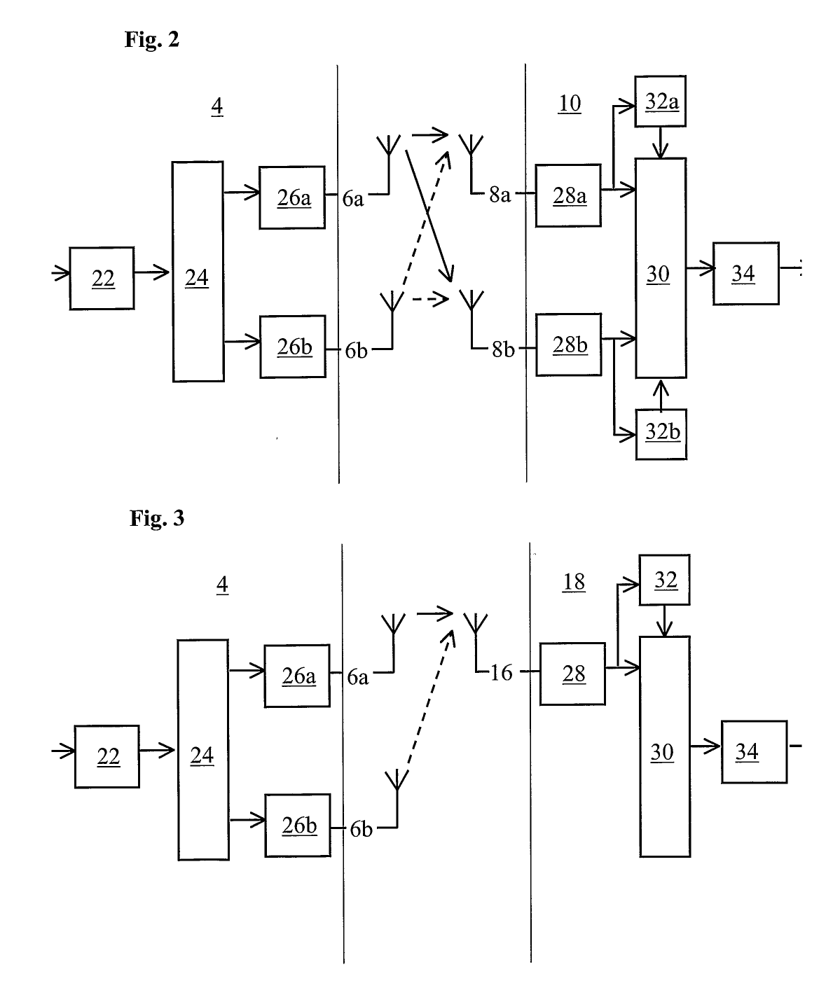

This technique is applied in the present embodiment as shown in FIG. 2. The wireless gateway 4 outputs the data stream to be transmitted to a mapper 22 which maps the data onto pairs of symbols which are output to an encoder 24 which generates the symbols, their negatives and complex conjugates as described above. The output to the first antenna 6a is modulated by a first modulator 26a and the output to the second antenna 6b is output to a second modulator 26b, and are transmitted.

Although the two symbols transmitted at any one time are transmitted with different polarisation between the two transmit antennas 6a, 6b, the signals received at the receive antennas 8a, 8b each comprise a component of both symbols, with variable phase shift, polarisation and attenuation. The orthogonal polarisation between the symbols is not preserved in transmission, as a result of reflection and transmission through different materials. Furthermore, there is no requirement that the polarisation of the transmit antennas 6a, 6b be aligned with that of the receive antennas 8a, 8b.

At the first wireless receiver 10, the input from each antenna 8a, 8b is demodulated by a respective demodulator 28a, 28b and the result output to a respective channel estimator 32a, 32b and to a maximum likelihood detector 30 to derive the transmitted symbols. The result is de-mapped from the symbols to the data stream by a de-mapper 34, and is output to subsequent stages.

Note that STBC can also be used with only one receive antenna, as shown in FIG. 3 in the case of the second wireless transceiver 18 and explained in Alamouti.

Hence, the preferred embodiment uses polarisation-time block coding (PTBC).

The effect of the different diversity techniques was tested using a narrowband 802.11a simulator for each of the 7 modes of operation, as follows:

| Mode | Modulation | Code Rate | Max Throughput (Mbit/s) |
|---|---|---|---|
| 1 | BPSK | ½ | 6 |
| 2 | BPSK | ¾ | 9 |
| 3 | QPSK | ½ | 12 |
| 4 | QPSK | ¾ | 18 |
| 5 | 16-QAM | ½ | 24 |
| 6 | 16-QAM | ¾ | 36 |
| 7 | 64-QAM | ¾ | 54 |

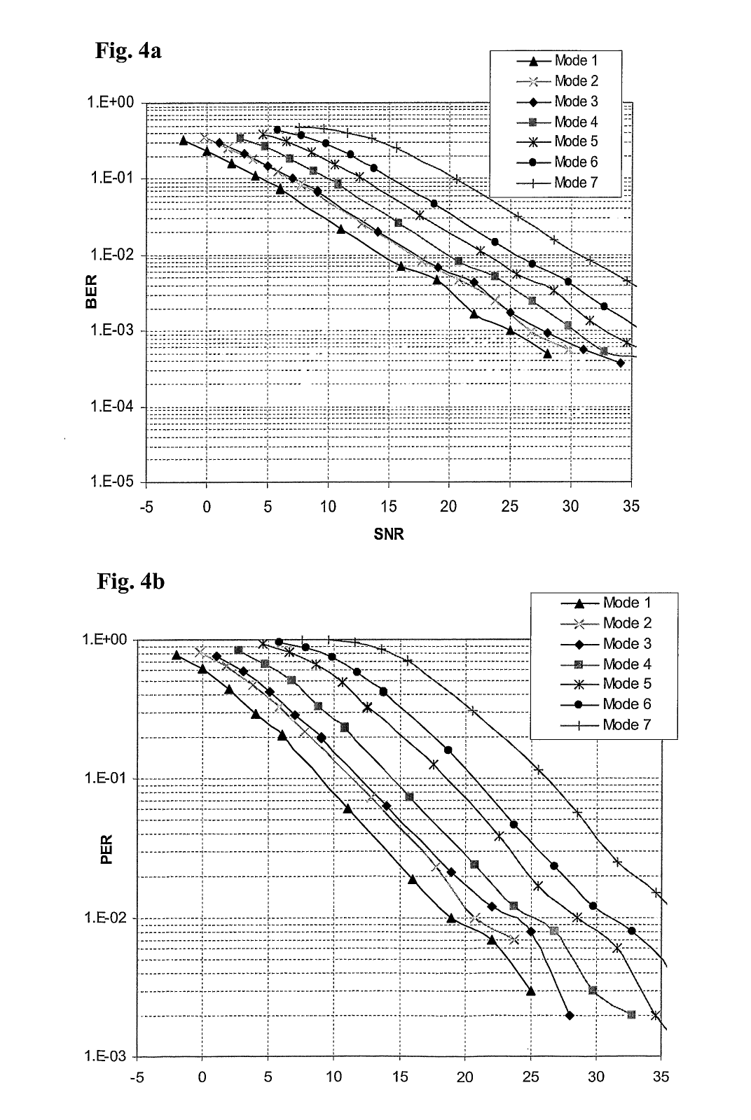

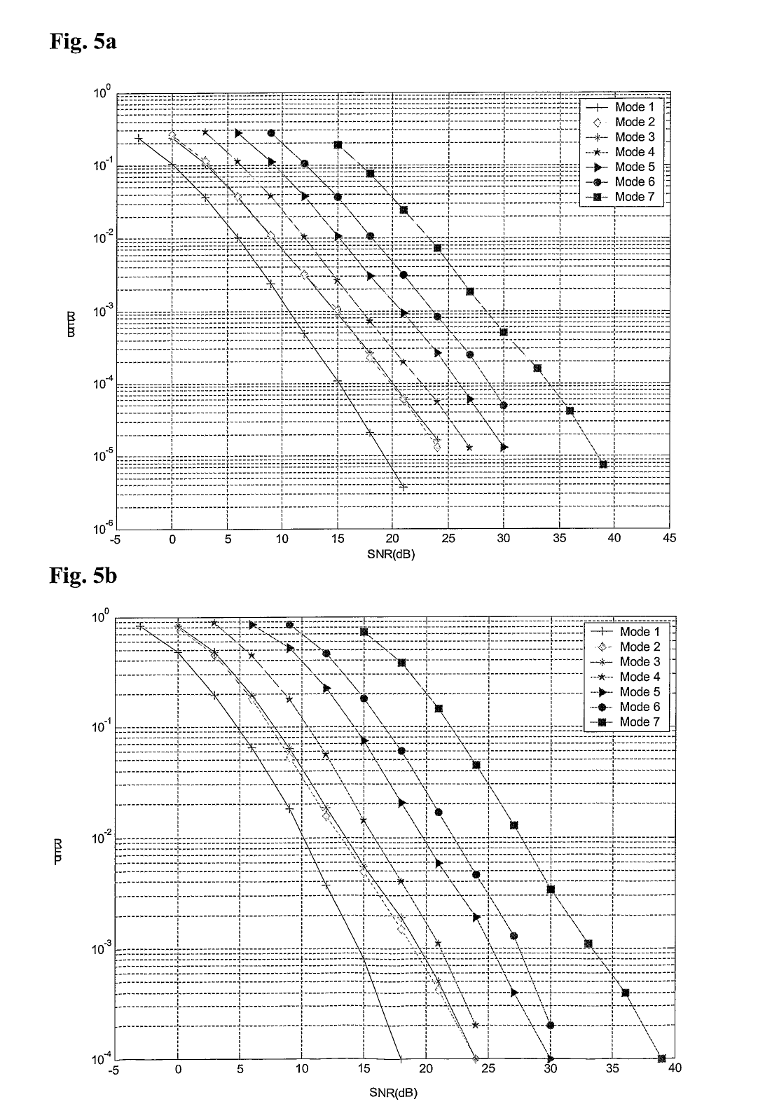

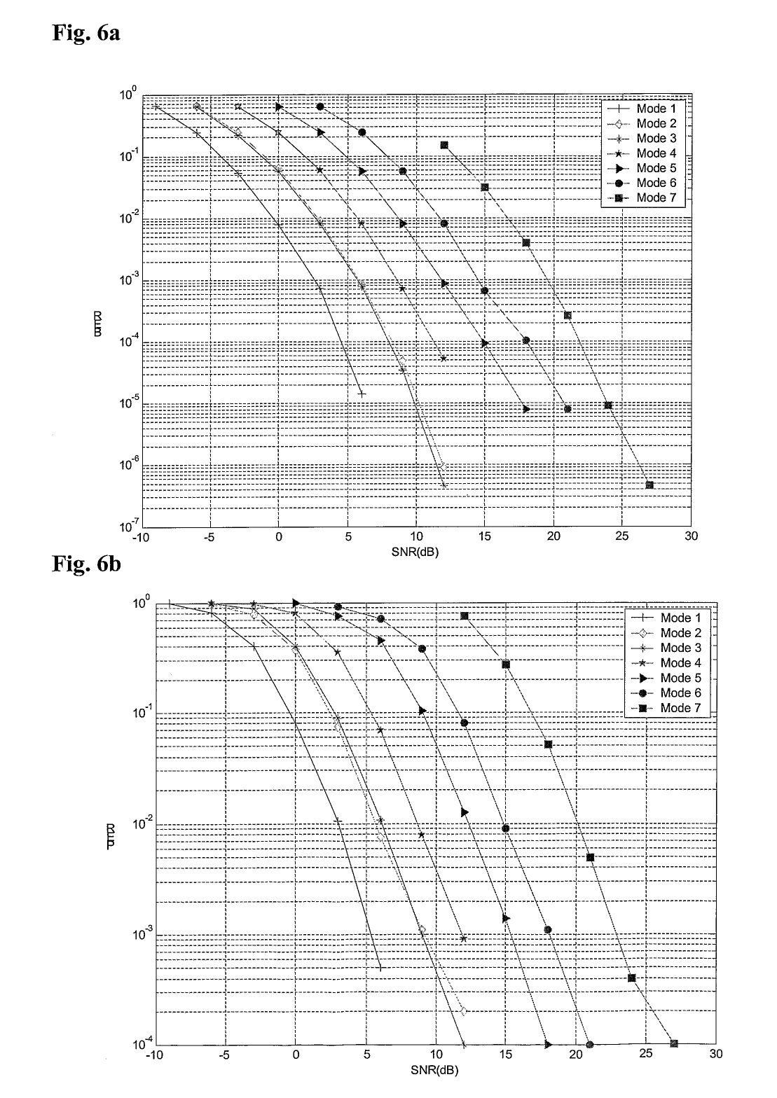

FIGS. 4a and 4b show the bit error rate (BER) and packet error rate (PER), for a packet size of 54 bytes, against signal to noise ration (SNR), without any diversity technique. FIGS. 5a and 5b show the equivalent results using PTBC with two transmit and one receive antennas, while FIGS. 6a and 6b show the equivalent results with two transmit and two receive antennas.

### OFDM

The polarisation-time block coding described above can be applied to wideband transmission, such as OFDM, as well as narrowband. In OFDM, a data stream is multiplexed redundantly between multiple orthogonal frequency channels, which helps to overcome frequency-selective fading of the radio channel such as multi-path fading; see for example “A space-time coded transmitter diversity technique for frequency selective fading channels”, Lee K F and Williams D B, Sensor Array and Multichannel Signal Processing Workshop, 2000, pp. 149-152. In an embodiment using OFDM, the modulators 26a, 26b are multicarrier modulators and the demodulators 28a, 28b are multicarrier demodulators. Channel estimation and maximum likelihood detection is performed independently on each frequency carrier. This embodiment can be used to implement the 802.11a standard, which uses OFDM.

### Linear Slot Antenna

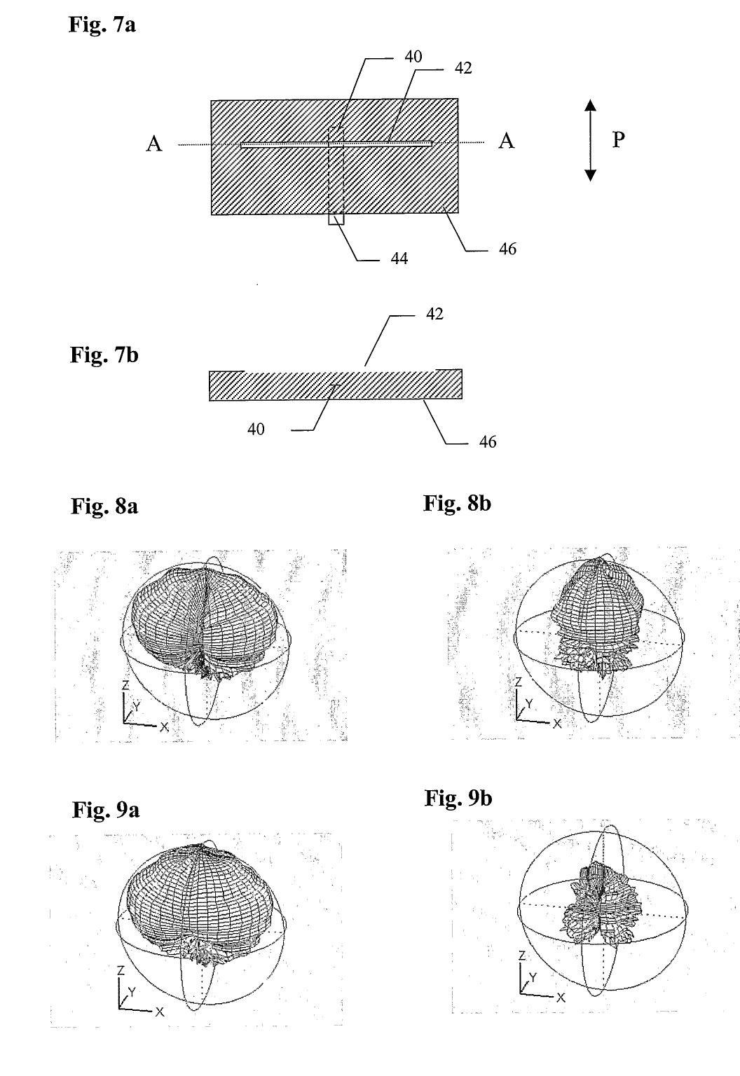

Preferred forms of antenna for the transmit and receive antennas will now be described. A first form of antenna is a linear slot antenna as shown in FIGS. 7a and 7b, which show respectively a plan view and a cross section through the plane A-A. The linear slot antenna comprises a cavity 46 with a slot 42 etched in the top surface. The signal to the antenna is fed via a connector 44 to a strip conductor 40 located in the centre of the cavity. The base of the cavity 46 is mounted on a ground plane. The direction of polarisation is shown by the arrow P in FIG. 7a.

A prototype of the linear slot antenna was constructed by sandwiching the strip conductor 40 between two rectangular pieces of dielectric board, each clad with copper on its outer surface. The board may be RT/Duroid, with a dielectric constant of 2.2. The slot 42 was etched into one outer surface, and the edges of the boards were sealed with copper foil to form the cavity 46. An SMA connector port 44 was attached to the end of the strip conductor 40 protruding from the cavity 46. In this example, the antenna was designed for use both at the 2.4 and 5.2 GHz bands and had dimensions of 50×20×3.2 mm.

The linear slot antenna was mounted on a 250×250 mm ground plane and the far field gain at 5.2 GHz at different polarisations was measured in three dimensions. FIGS. 8a and 8b show the gain for horizontal and vertical polarisation respectively. The data were also processed to give the co-polar pattern shown in FIG. 9a, and the cross-polar pattern shown in FIG. 9b. The co-polar pattern is clearly dominant. Ripples in the patterns may be due to ground plane diffraction. The pattern shows a broad beam similar to that of a dipole, but essentially hemispherical due to the ground plane. Similar results were obtained at 2.4 GHz, apart from lower efficiency and directivity because of the smaller size of the ground plane compared to the wavelength. A summary of the pattern performance is shown below:

| Frequency | Directivity | Co/XP | | Max Position |
|---|---|---|---|---|
| GHz | dBi | dB | Co-polar Power % | θ°, φ° |
| 2.4 | 6.7 | 13.4 | 97.5 | 36, −10 |
| 5.2 | 8.2 | 15.4 | 97.6 | 2, −80 |

### Annular Slot Antenna

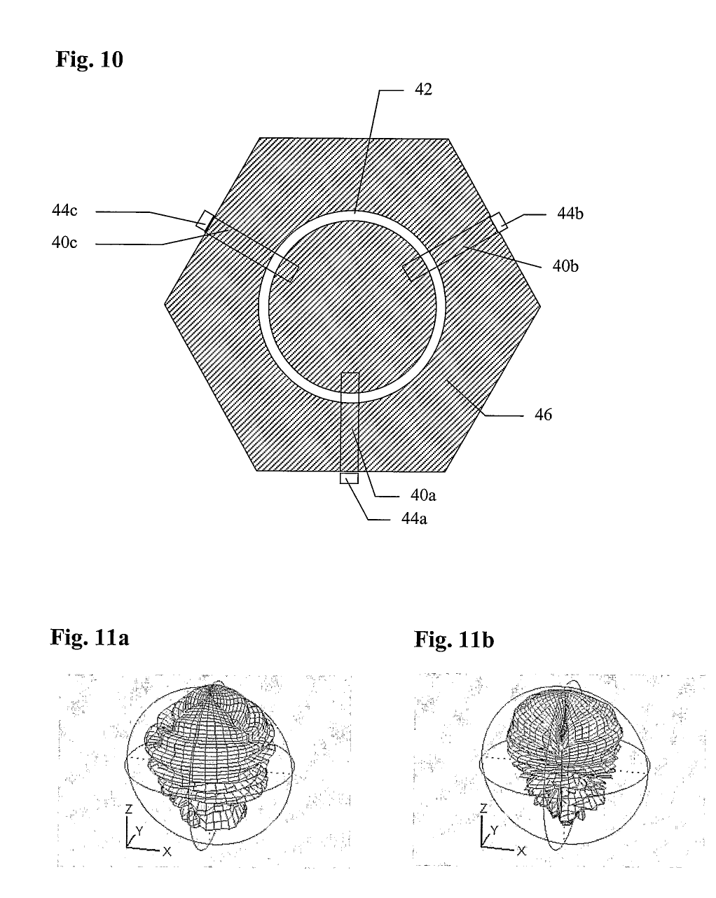

A second form of slot antenna suitable for use in embodiments of the invention is an annular slot antenna, as shown in FIG. 10. The annular slot antenna is similar to the linear slot antenna except that it has an annular slot 42 in the top surface of the cavity 46, which is hexagonal, and has three ports 44a, 44b, 44c to corresponding strip conductors 40a, 40b, 40c extending towards the centre of the hexagon and parallel to and equidistant from the upper and lower faces of the cavity 46.

The far field antenna pattern of the annular slot antenna is shown in FIG. 11a, for horizontal polarisation, and FIG. 11b for vertical polarisation, when one of the ports 44a is fed with a signal. The antenna patterns caused by feeding a signal to one of the other ports 44b, 44c are rotated by 120° with respect to the patterns shown.

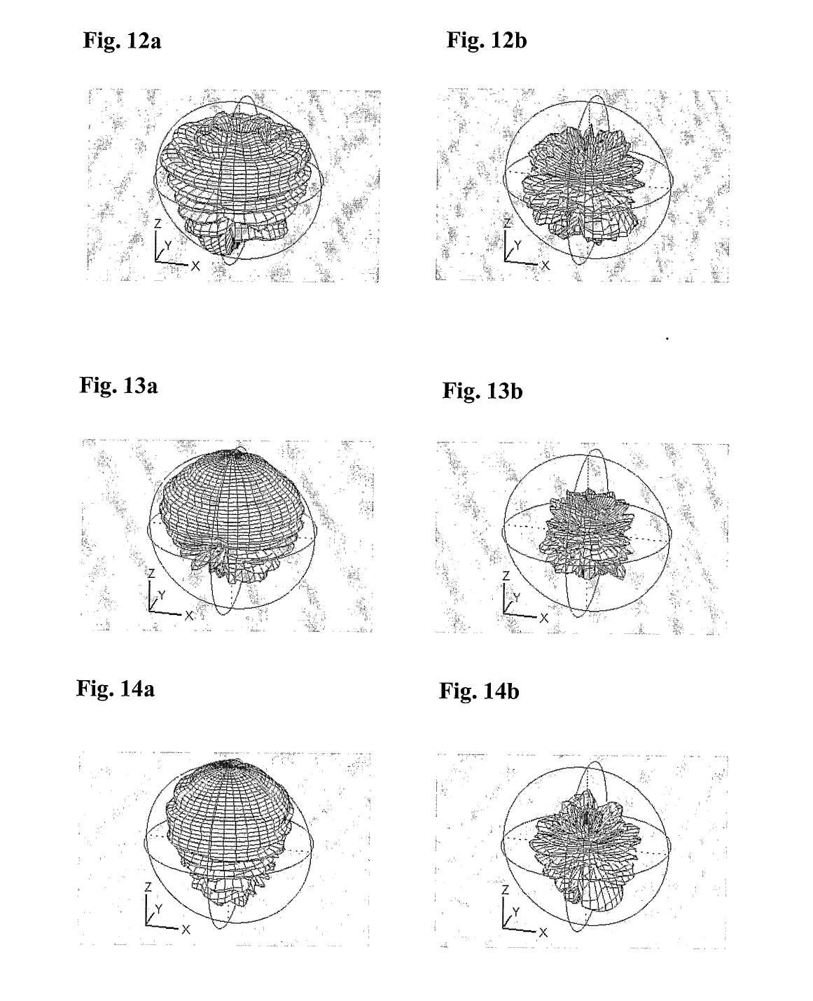

By feeding more than one of the ports with signals of differing phase or amplitude, different beam patterns can be created. For example, FIGS. 12a and 12b show the co-polar and cross-polar responses respectively for applying the same signal to each port (i.e. A+B+C). The result is similar to a pattern produced by a monopole above a ground plane. FIGS. 13a and 13b show co-polar and cross-polar responses respectively for applying two signals in antiphase to two of the ports 44b, 44c (i.e. B−C). The result is a broad polarised beam. FIGS. 14a and 14b show co-polar and cross-polar responses respectively for applying a signal to the port 44a and applying the signal in antiphase with half the amplitude to the other two ports 44b, 44c (i.e. A−(B+C)/2). The result is a broad beam polarised and directed orthogonally to that of FIGS. 13a and 13b.

Hence, a single annular slot antenna can produce two orthogonally polarised beams with one beam overlapping the null of the other, and can be used to implement the two antennas 6a, 6b or 8a, 8b.

### Antenna Mounting

The dimensions of the linear and annular slot antennas allow them to be conveniently mounted on the outer surface of a metallic housing, such as a housing for the wireless gateway 4. The surface of the housing then acts as a ground plane. Moreover, this allows the antenna to be mounted substantially flush to the outer surface of the wireless gateway 4, preferably protected by non-conductive cover of low dielectric constant material, such as plastic.

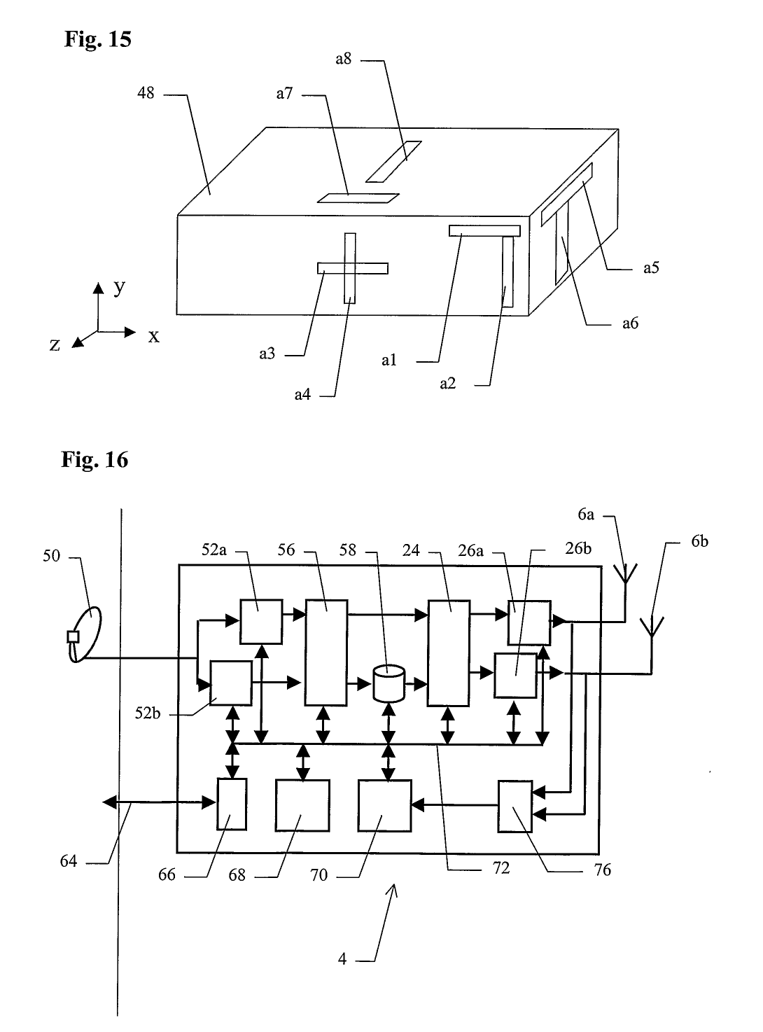

FIG. 15 shows a cuboid housing 48 for the wireless gateway 4, showing possible positions a1-a8 for the slot 42 of the linear slot antenna on the top, front and side faces of the housing 48. The direction of x, y and z axes are also shown, parallel to the width, height and depth respectively of the housing 48. Positions a1, a3 and a7 are x-directed, a2, a4 and a6 are y-directed, and a5 and a8 are z-directed. To achieve orthogonal polarisation between pairs of linear slot antennas, they must be directed along different axes, or at least have substantial extent along different axes.

The antenna pattern for each of the positions a1-a8, and for combinations of orthogonal pairs of positions, were tested. The main difference between antenna patterns in different positions is in the orientation of the antenna pattern, and the effect of the different dimensions of the faces of the housing 48 on which the antennas were mounted, and which act as ground planes. Better performance is achieved where the ground plane is larger, as for example with positions a7 and a8. However, the optimum coverage pattern was achieved for the combination of positions a3 and a4, in which the antennas are substantially collocated but orthogonal. These positions could be rotated by 45° parallel to the front face to reduce the effect of the relatively short height of the housing 48. In this example, the dimensions of the housing 48 were 300×60'210 mm in the x, y and z directions shown in FIG. 15.

As can be seen from FIGS. 8a and 9a, the pattern of the linear slot antenna comprises directional beams in the +x and −x direction of those Figures, and a null in the +y and −y directions. If a similar orthogonal antenna is added in the x-y plane, the directional beams of one antenna overlap the nulls of the other, giving a pattern that is substantially omnidirectional about the z axis, and in elevation from the x-y plane. Hence, independently from the advantage of providing polarisation diversity, the orthogonal slot antennas provide a substantially omnidirectional coverage pattern, at least in one hemisphere. This arrangement helps to avoid the nulls that are frequently found when using a wireless network in the home environment. The orthogonal antennas provide substantially uniform coverage in three dimensions, allowing the network to be used between floors as well as in different rooms on the same floor.

More than one pair of transmit antennas 6a, 6b or receive antennas 8a, 8b can be used by the same device. For example, if complete spherical coverage were required, one pair of antennas could be positioned on each of two opposite faces of the housing 48, with one of each pair being driven by the same signal.

A similar orthogonal antenna arrangement can be used in the first wireless receiver 10. The combined uniform coverage of the orthogonal antennas means that the receiver device does not have to be aligned with the transmit antennas 6a, 6b to achieve good reception. This is particularly important where the receiver 10 is portable.

The coverage advantages of the orthogonal slot antennas are particularly marked when data is transmitted redundantly between the different polarisations of the transmit antennas, as is the case with the polarisation-time block codes described above. If a receiver is located in the null of one antenna, then the data can still be received in the directed beam of the other antenna.

### Wireless Satellite Broadcast Gateway

Details of a wireless gateway 4 in one specific embodiment of the invention are shown in FIG. 16. In this embodiment, the wireless gateway 4 includes a satellite broadcast receiver, integrated within the housing 48. The satellite broadcast receiver in this embodiment is based on the applicant's Sky^{+ RTM} set top box.

A dish antenna 50 receives satellite television broadcast signals from a satellite television broadcast network. The received signals are input to first and second tuners 52a, 52b, although any plural number of tuners may be used. The tuners 52a, 52b are tuneable into the same or different channels of the satellite television broadcast network for simultaneous reception of the same or different television programmes. Signals from the first and second tuners 52a and 52b are passed to a Quadrature Phase Shift Key (QPSK) demodulator 56, which may also perform forward error correction. The gateway 4 has a hard disk 58 which receives from the demodulator 56 compressed video and audio data representing received television programmes for recording and subsequent playback.

The received signals comprise digitally encoded data. In this example, the data is compressed using the Digital Video Broadcast/Moving Pictures Expert Group 2 (DVB/MPEG 2) standard which permits both programme data and additional data (for example interactive service data) to be transmitted in a single channel. DVB/MPEG 2 enables high compression ratios to be achieved. The data may include both media data, such as video data and audio data, and service data, such as user services data and programme scheduling data. The service data may be processed and stored separately from the media data, and used to provide programme guide functionality. The hard disk 58 receives and stores the compressed and encrypted media data.

The functions of the wireless gateway 4, including the receiver, are controlled by a processor 70 which is interconnected to the other components by a bus 72. The processor 70 has access to memory 68, including RAM, flash memory for storing an operating system and applications, and ROM.

The processor 70 controls operation of the receiver by tuning the tuners 52a and 52b to receive signals for the desired channels and by controlling the hard disk 58 to record desired television programmes or to play back previously recorded television programmes. Viewer selection of desired programmes and customer services is controlled by remote user commands received via one or both of the antennas 6a, 6b and decoded by a command receiver 76. The commands use a low bandwidth signal and therefore do not require diversity reception, although this may be used.

A selected programme or service is output as an encrypted media stream, either directly from the demodulator 56 or from the hard disc 58, to the STBC encoder 24, which for sake of clarity includes the mapper function 22, and the modulators 26a and 26b, for transmission through the antennas 6a, 6b using the PTBC transmission technique described above.

The MAC layer and wireless network protocol may be implemented by the processor 70 and/or by a dedicated chipset. In this example, the network protocols are in accordance with the 802.11a standard, with transmission in the 5.2 GHz band. Preferably, operation is restricted to modes 5, 6 and 7 to provide the necessary bandwidth for at least one video stream. The MAC layer of Hiperlan/2, 802.11 or 802.11e may be used.

The network protocol allows simultaneous transmission of different media streams to different receivers 10, 18, if sufficient bandwidth is available. The wireless gateway is capable of reading multiple streams substantially simultaneously from the hard disc 58, for example by using multiple heads, a hard disk array with redundancy, or time-divided reading and buffering, and/or from the demodulator 56.

The wireless gateway may include a data communications interface 66, such as a dial-up modem for connection to a PSTN, or a DSL modem, to allow interactive communication services with a remote system, and to receive streaming media data from the internet.

### Wireless Receivers

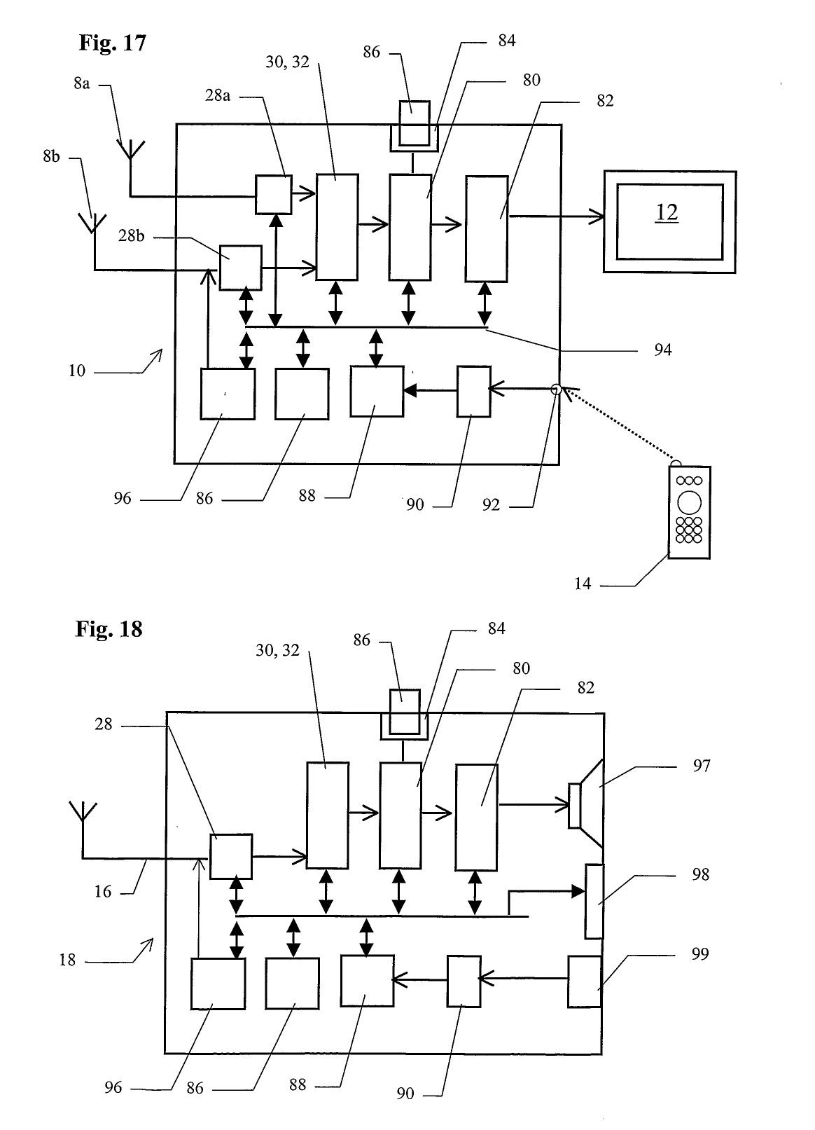

A more detailed diagram of the receiver 10 for use with the wireless gateway 4 in this embodiment will now be described with reference to FIG. 17. The receiver 10 includes the receive antennas 8a, 8b, demodulators 28a, 28b, channel estimators 32a, 32b and maximum likelihood detector 30, as in FIG. 2, and receives and decodes a media stream using maximum ratio combining, as described above.

The decoded media stream is passed to a media decoder 80 which decrypts the media stream and decodes it using the MPEG 2 standard into audio and video data. The decryption may be by means of an encryption key stored on a smart card 86 and read by a smart card reader 84. The audio and video data are converted by a video interface 82 for output to the audiovisual display 12. The video interface 82 may be a SCART interface.

The remote control 14 has user actuable keys which generate corresponding IR codes, for example as defined by the RC6 standard developed by Philips. These signals are received by an IR receiver 92, decoded by a command decoder 90, and input to a processor 88 which is connected to the components of the receiver by a bus 94. The processor 88 sends corresponding command signals via a modulator 96 and one or both of the antennas 8a, 8b over the wireless network to the wireless gateway 4.

The wireless gateway 4 responds to the command signals by varying the content of the media stream sent to the receiver 10 over the wireless network. For example, the user may use the remote control 14 to change the received television programme, to skip or scan backwards or forwards through the received television programme, or to change the channel received by either of the tuners 52a, 52b. The user may also interact with an interactive programme executed by the wireless gateway 4.

A detailed version of the second receiver 18 in this embodiment is shown in FIG. 18. Similar parts to those of the first receiver 10 are shown with the same reference numerals, and their description is not repeated here. In this specific embodiment, the second receiver is an integrated portable wireless audio device, in which the audio player is integrated with the receiver 18. The device includes at least one speaker 97 (preferably stereo speakers), a keypad 99 which generates command signals, and a display 98 which displays programme information. In this embodiment, the second receiver 18 can decrypt and decode audio streams, such as radio programmes, or the audio content of television programmes, received by the wireless gateway 4 and/or retrieved from the hard disc 58. Only one antenna 16 is used for receiving the audio stream and transmitting the user commands, but two antennas could be used with reception diversity and maximal ratio combining as in the first receiver 10, if better reception performance is required.

### Alternative Embodiments

The above embodiments have been described by way of example and are not intended to limit the scope of the present invention. Other alternatives may be envisaged on reading the above description, which may nevertheless fall within the scope of the present invention.

1. A wireless local area network device, having an antenna arrangement for transmitting first and second orthogonally polarised beams and arranged to transmit digitally modulated data as modulated symbols with redundancy between the first and second beams.

2. The device of claim 1, wherein the symbols are transmitted using a polarisation-time block code.

3. The device of claim 2, wherein each symbol is transmitted unmodified in a first time period and as a complex conjugate in a second time period.

4. The device of claim 3, wherein the symbols are encoded in pairs such that each pair of symbols is transmitted unmodified in a first period, and in a second period, one of the pair is transmitted as a complex conjugate, while the other of the pair is transmitted as a negative complex conjugate.

5. The device of claim 1, arranged to transmit the data using orthogonal frequency division multiplexing.

6. The device of claim 1, wherein each modulated symbol is transmitted with redundancy in frequency.

7. The device of claim 1, wherein the first and second beams are each directional beams including at least one null, wherein the first directional beam overlaps the null of the second directional beam.

8. The device of claim 1, wherein the antenna arrangement comprises first and second slot antennas.

9. The device of claim 8, wherein the first and second antennas are linear slot antennas having orthogonally arranged slots.

10. The device of claim 7, wherein the antenna arrangement comprises an annular slot antenna.

11. The device of claim 1, including a housing having one or more substantially planar surfaces, wherein each of the first and second antennas is substantially planar and arranged parallel to one of the substantially planar surfaces.

12. The device of claim 11, wherein each of the first and second antennas is substantially coplanar with one of the substantially planar surfaces.

13. The device of claim 11, wherein the one or more substantially planar surfaces are electrically conductive.

14. The device of claim 1, wherein said data comprises a media stream.

15. The device of claim 14, wherein the device includes means for receiving the content of the media stream from a source outside the local area network.

16. The device of claim 15, wherein the means for receiving comprises a television broadcast receiver, wherein the device is arranged to transmit a television programme, received by the television broadcast receiver, over the local area network as the media stream.

17. The device of claim 16, wherein the device includes means for storing the television programme prior to transmission over the local area network.

18. The device of claim 14, wherein the device is arranged to transmit said media stream to a receiver device over said network, and to vary the content of the media stream in response to a command received from the receiver device over the local area network.

19. A wireless local area network device, having an antenna arrangement for receiving first and second signals with orthogonal polarisation and arranged to receive digitally modulated data transmitted with redundancy between the orthogonal polarisations.

20. The device of claim 19, wherein the device is arranged to decode the data received through the first and second signals using maximal ratio combining.

21. The device of claim 19, wherein the data is encoded using a polarisation-time block code.

22. The device of claim 19, wherein the antenna arrangement is arranged to generate first and second directional beams each having at least one null, wherein the first directional beam overlaps the null of the second directional beam.

23. The device of claim 22, wherein the antenna arrangement comprises one or more slot antennas.

24. The device of claim 23, wherein the antenna arrangement comprises first and second linear slot antennas having orthogonally arranged slots.

25. The device of claim 23, including a housing having one or more substantially planar surfaces, wherein the one or more slot antennas are substantially planar and arranged parallel to one of the substantially planar surfaces.

26. The device of claim 25, wherein the one or more slot antennas are each substantially coplanar with one of the substantially planar surfaces.

27. The device of claim 25, wherein the one or more substantially planar surfaces are electrically conductive.

28. The device of claim 19, wherein the data comprises a media stream, the device being arranged to decode and output said media stream.

29. The device of claim 28, wherein the media stream comprises an encoded video stream, and the device is arranged to decode the encoded video stream prior to output.

30. The device of claim 28, wherein the media stream is encrypted, and the device is arranged to decrypt the encrypted media stream prior to output.

31. The device of claim 28, including means for transmitting a control command over the local area network so as to vary the content of the media stream.

32. A wireless local area network comprising a transmitter arranged to transmit digitally modulated data with redundancy between first and second orthogonal polarisations, and one or more receivers, each arranged to receive said digitally modulated data.

33. The network of claim 32, wherein at least one of the receivers is arranged to receive the data in first and second signals with orthogonal polarisations.

34. The network of claim 33, wherein the at least one receiver is arranged to decode the data using maximal ratio combining.

35. The network of claim 32, wherein the data is transmitted using a polarisation-time block code.

36. The network of claim 32, wherein the transmitter is arranged to transmit one or more media streams over the network to the one or more receivers.

37. The network of claim 36, wherein the transmitter is arranged to receive one or more media programmes from a source outside the local area network, wherein said one or more media streams are derived from said one or more media programmes.

38. The network of claim 37, wherein the transmitter includes a broadcast receiver for receiving said one or more media programmes.

39. The network of claim 37, wherein the media programmes are encrypted prior to reception by the transmitter, and the one or more receivers are arranged to decrypt the media streams derived from said encrypted media programmes.

40. The network of claim 36, wherein at least one of the receivers includes means for transmitting control commands to the transmitter over the wireless network so as to vary the content of one of the media streams received by that receiver.

41. A wireless local area network device, having at least first and second antennas, arranged to transmit modulated data with redundancy between the first and second antennas, wherein the far field pattern of each of the antennas includes a directional beam and a null, and the beam of the first antenna is arranged to overlap the null of the second antenna.

42. The device of claim 41, wherein the first and second antennas are orthogonally polarised.

43. The device of claim 42, wherein the first and second antennas are slot antennas.

44. The device of claim 43, wherein the first and second antennas are linear slot antennas having orthogonally arranged slots.

45. The device of claim 41, including a housing having one or more substantially planar surfaces, wherein each of the first and second antennas is substantially planar and arranged parallel to one of the substantially planar surfaces.

46. The device of claim 45, wherein each of the first and second antennas is substantially coplanar with one of the substantially planar surfaces.

47. The device of claim 45, wherein the one or more substantially planar surfaces are electrically conductive.

48. A linear slot antenna, comprising first and second parallel conductive faces with conductive edges between the faces and a cavity between the faces with a thickness substantially less than the dimensions of the first and second faces, a linear slot in the first conductive face and a strip conductor arranged substantially centrally within the cavity and orthogonally to the slot.

49. The antenna of claim 48, wherein the second face is mounted on a ground plane.

50. The antenna of claim 49, wherein the ground plane is a planar conductive surface of a housing of a wireless network device.

51. A wireless network device having a housing including a planar conductive surface and a linear slot antenna mounted on the planar conductive surface.

52. An annular slot antenna, comprising first and second parallel conductive faces with conductive edges between the faces and a cavity between the faces with a thickness substantially less than the dimensions of the first and second faces, an annular slot in the first conductive face and at least first and second mutually angularly displaced strip conductors arranged substantially centrally within the cavity and orthogonally to the circumference of the annular slot.

53. The antenna of claim 52, wherein the second face is mounted on a ground plane.

54. The antenna of claim 53, wherein the ground plane is a planar conductive surface of a housing of wireless network device.

55. The antenna of claim 52, arranged to receive a signal with a phase difference between the first and second strip conductors, so as to generate a polarised beam.

56. An annular slot antenna, comprising first and second parallel conductive faces with conductive edges between the faces and a cavity between the faces with a thickness substantially less than the dimensions of the first and second faces, an annular slot in the first conductive face and first, second and third strip conductors equiangularly spaced and arranged substantially centrally within the cavity and orthogonally to the circumference of the annular slot.

57. The antenna of claim 56, wherein the first and second parallel conductive faces are substantially hexagonal.

58. The antenna of claim 56, arranged to receive a signal at the first strip conductor and the signal in antiphase at the second strip conductor, so as to generate a polarised beam.

59. The antenna of claim 58, further arranged to receive the signal in antiphase at the third strip conductor.

60. The antenna of claim 59, wherein each said antiphase signal has approximately half the amplitude of the signal at the first strip conductor.

61. A wireless network device having a housing including a planar conductive surface and an annular slot antenna mounted on the planar conductive surface.

62. A wireless media device arranged to transmit one or more media streams over a local area network to one or more receivers, the device including first and second orthogonally arranged linear slot antennas and being arranged to transmit said one or media streams through the first and second antennas using space-time block codes.

63. A wireless media network comprising a wireless media transmitter arranged to transmit one or more media streams over a local area network to one or more receivers, the transmitter including first and second orthogonally polarised linear slot antennas and being arranged to transmit said one or media streams through the first and second antennas using polarisation-time block codes, and the one or more receivers including means for decoding signals received from the first and second antennas using maximal ratio combining.

64. A wireless media gateway device arranged to receive one or more media programmes and to transmit said one or more media programmes over a local area network, the device including first and second orthogonally arranged linear slot antennas and being arranged to transmit said one or media programmes through the first and second antennas using space-time block codes.
